(19) United States
(12) Patent Application Publication
(10) Pub. No.: US 2026/0110868 A1
(43) Pub. Date: Apr. 23, 2026

(54) FIBER ENTRY POINT ENCLOSURE WITH FIBER OPTIC TRAYS AND INTEGRATED WORKBENCH

(71) Applicant: Leviton Manufacturing Co., Inc., Melville, NY (US)

(72) Inventors: Bret Kendall Taylor, Seattle, WA (US); Yuk Kwan Sylvanus Lee, Bothell, WA (US); Jon Clark Riley, Redmond, WA (US)

(21) Appl. No.: 19/158,235

(22) PCT Filed: Jul. 11, 2025
(86) PCT No.: PCT/US2025/037400

§ 371 Date: Aug. 20, 2025

Related U.S. Application Data
(60) Provisional application No. 63/672,954, filed on Jul. 18, 2024.

(51) Int. Cl. G02B 6/44

(52) U.S. Cl. CPC G02B 6/44524; G02B 6/4454

(57) ABSTRACT

A fiber optic enclosure includes a number of organizational features that simplify fiber routing and installation and that yield improved organization of fiber bundles. For instance, a fiber optic enclosure can comprise an enclosure body, one or more trunk mounting plates mounted inside the enclosure body at an angle relative to a rear wall of the enclosure body, and a subframe below the trunk mounting plates and configured to hold fiber optic trays in a vertical arrangement.

### CROSS-REFERENCE TO RELATED APPLICATION

This application claims priority to U.S. Provisional Application Ser. No. 63/672,954, filed on Jul. 18, 2024, and entitled “FIBER ENTRY POINT ENCLOSURE WITH FIBER OPTIC TRAYS AND INTEGRATED WORKBENCH,” the entirety of which is incorporated by reference.

### TECHNICAL FIELD

The disclosed subject matter relates generally to fiber optic enclosures

### BACKGROUND

Fiber optic cables are often used as a medium for telecommunication and computer networking due to their flexibility, high data capacity, and immunity to interference. Since light is used as the data transmission medium, fiber optic cables can carry data over long distances with little attenuation relative to electrical data transmission. Fiber optic cables are used in many types of applications and contexts, including data centers, local area networks that use optical transceivers, corporate intranets that deploy optical pathways for high-speed transmission of data on a corporate campus, or other such data transmission applications.

For data communication installations requiring large numbers of fiber optic pathways, such as data centers, fiber optic trunks carrying large numbers of optical fibers are typically routed to the location at which individual fibers will be connected to end devices or ports, and the trunks optical fibers are separated into bundles or loops and routed to their respective termination points.

The foregoing is merely intended to provide an overview of fiber optic installation contexts relevant to the solutions described herein. Problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a fiber optic enclosure that can serve as a fiber entry point for a data center or other such fiber optic installations. Features of the enclosure can promote ease of fiber installation and organized routing of optical fibers from incoming and outgoing fiber optic trunks to fiber optic trays mounted in the enclosure. The enclosure also includes an integrated removable workbench that can be mounted below the fiber optic trays and that supports a fiber optic splicing device, providing installers with a work surface on which to splice fibers and organize the spliced fibers into their corresponding trays.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a perspective view of an example fiber optic enclosure.

FIG. 2 is a front view of the example fiber optic enclosure.

FIG. 3 is a close-up view of a subframe and fiber optic trays within the example fiber optic enclosure.

FIG. 4 is a close-up view of trunk mounting plates within the example fiber optic enclosure.

FIG. 5 is a view of a single front trunk mounting plate.

FIG. 6 is a top view of the enclosure illustrating entry of fiber optic trunks into the example fiber optic enclosure.

FIG. 7 is another top view of the enclosure depicting the example fiber optic enclosure's lid in its home position.

FIG. 8 is a top view of the example fiber optic enclosure in which an alternative trunk entry design is used.

FIG. 9 is a perspective view of example fiber optic enclosure with the door attached, showing a workbench fastened to the door.

FIG. 10 is a view of the example fiber optic enclosure depicting the workbench installed in the subframe.

FIG. 11 is a close-up view of a hooked mounting arm inserted into a left-side mounting hole of the subframe.

FIG. 12 is a close-up view of a teardrop hole with the end of a workbench cable inserted.

FIG. 13 is an example splice tray that can be installed in the subframe and used to hold spliced optical fibers.

FIG. 14 is a top view of a base tray.

FIG. 15 is a top view of the splice tray illustrating the use of fiber managers to retain fibers that are routed from the tray's entrance point to splice sleeve holders.

FIG. 16 is a close-up view of a portion of the splice sleeve holders.

FIG. 17 is a close-up view of a bridge feature located at the front portion of the base tray.

FIG. 18 is a close-up view of the splice tray illustrating additional projections for securing a lid.

FIG. 19 is a close-up view of the splice tray's entrance point.

FIG. 20 is a top view of the entrance point.

FIG. 21 is a perspective view of the entrance point.

FIG. 22 is a close-up view of the splice tray inserted into a deck.

FIG. 23 is a top view of an embodiment of the splice base tray that comprises two serpentine fiber paths.

FIG. 24 is a close-up view of the right-side serpentine path of the splice tray.

FIG. 25 is a closeup view of fiber manager components mounted on the splice tray.

FIG. 26 is a close-up view of the front portion of the splice tray depicting two additional rotatable and removable fiber manager components.

FIG. 27a is a perspective view of an example interconnect tray.

FIG. 27b is a perspective view of the interconnect tray with adapters omitted.

FIG. 27c is a perspective view of the interconnect tray with adapters installed.

FIG. 28 is a close-up view of the interconnect tray in which the adapters can be seen more closely.

FIG. 29 are front views of the enclosure illustrating versatility of door mounting.

FIG. 30 is a perspective view of the enclosure mounted on posts of a rack using a mounting bracket on each side.

FIG. 31 is a close-up view of the lower portion of the mounting bracket holding the enclosure in place on a post.

FIG. 32 is a close-up view of the lower portion of the mounting backet with the narrower flange anchored to the enclosure.

FIG. 33 is a close-up view of the lower portion of the enclosure illustrating example grounding mechanisms that can be built into the enclosure.

FIG. 34 is a view of the underside of the enclosure indicating locations of thread-forming screws through the floor of the enclosure.

FIG. 35 is a view of the rear side of the enclosure indicating locations of thread-forming screws through the rear and side walls of the enclosure.

FIG. 36 is a view of the subframe of the enclosure indicating locations of thread-forming screws that bond the sidewalls of the subframe to the subframe's lid.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Some reference numbers used herein to label illustrated components are suffixed with letters to delineate different instances of a same or similar component. In general, if a reference number without an appended letter is used within this disclosure, the descriptions ascribed to the reference number are to be understood to be applicable to all instances of that reference number with or without an appended letter unless described otherwise.

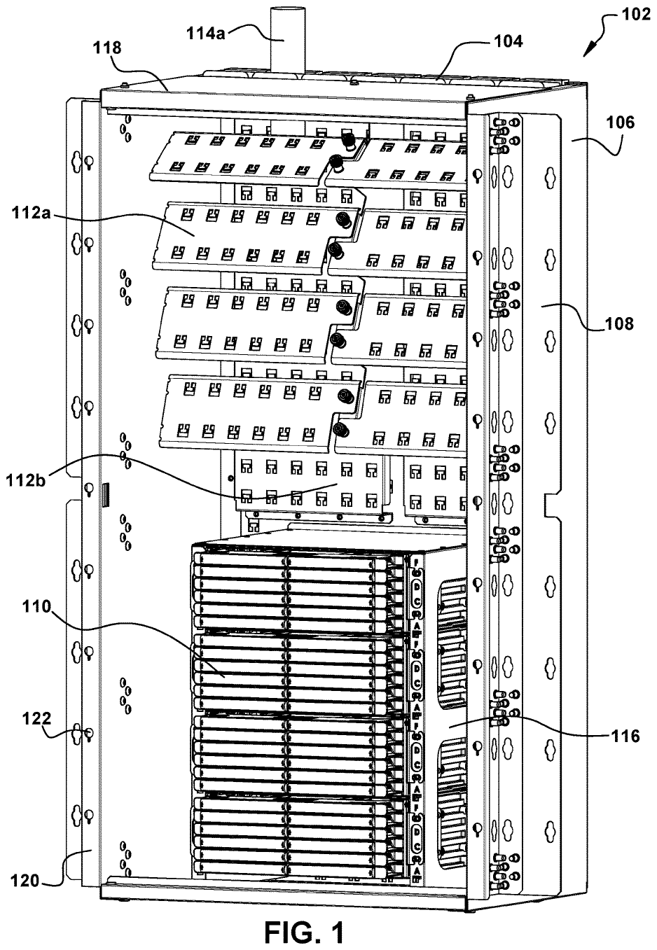

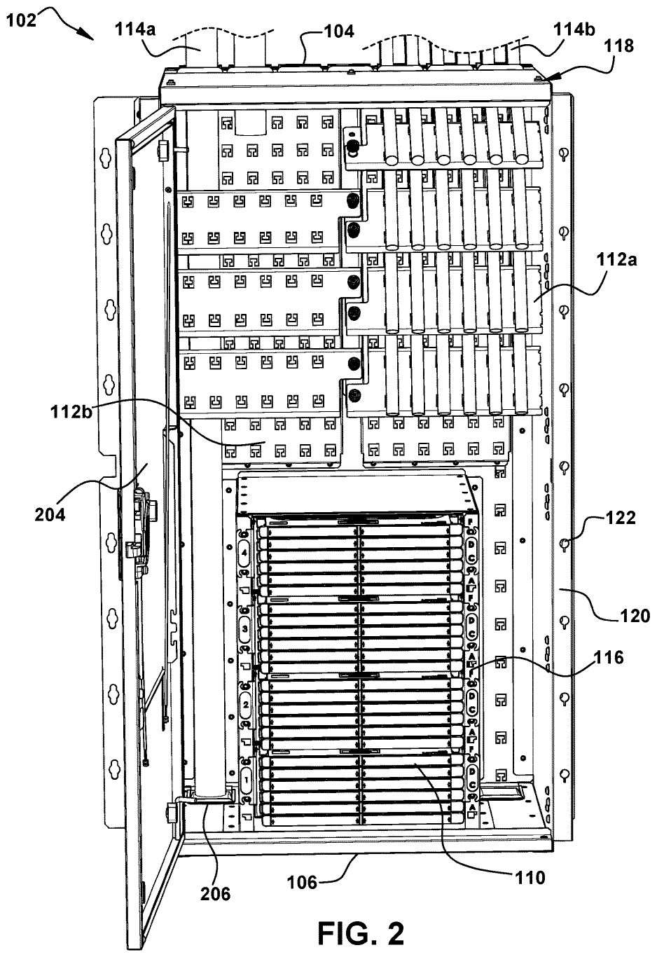

FIG. 1 is a perspective view of an example fiber optic enclosure 102 (also referred to herein as “the enclosure 102”) that can be used as a fiber entry point or an interconnection point for a data center or other installation contexts. The door of the enclosure 102 is omitted from FIG. 1 for clarity. FIG. 2 is a front view of the fiber optic enclosure 102. Fiber optic enclosure 102 comprises a main enclosure body 106 having a box-like shape. The top of the enclosure 102 comprises a removable lid 118 and a row of brushes 104 with flexible bristles that cover openings through which fiber optic trunks 114 can enter the enclosure 102, as will be described in more detail below. Trunks 114 that enter the enclosure 102 can be anchored to trunk mounting plates 112 within the enclosure 102 if fiber bundles from the trunks 114 are to be routed to fiber optic trays 110 (as with trunks 114b) or can be passed through the enclosure 102 to other destinations (such as adjacent enclosures 102) by entering through the top of the enclosure 102 and passing through a hole 206 on the floor of the enclosure 102 (as with trunk 114a). In general, enclosure 102 is designed to receive large numbers of optical fibers and to connect these fibers in an organized manner to other fibers that leave the enclosure 102.

A subframe 116 holding a number of fiber optic trays 110 is installed in the lower portion of the enclosure 102. The fiber optic trays 110 are installed in the subframe 116 such that the trays 110 can be individually slid forward to allow access to the optical fibers installed on each tray 110. Fibers of the incoming fiber optic trunks 114 can be spliced or connected within the fiber optic trays 110.

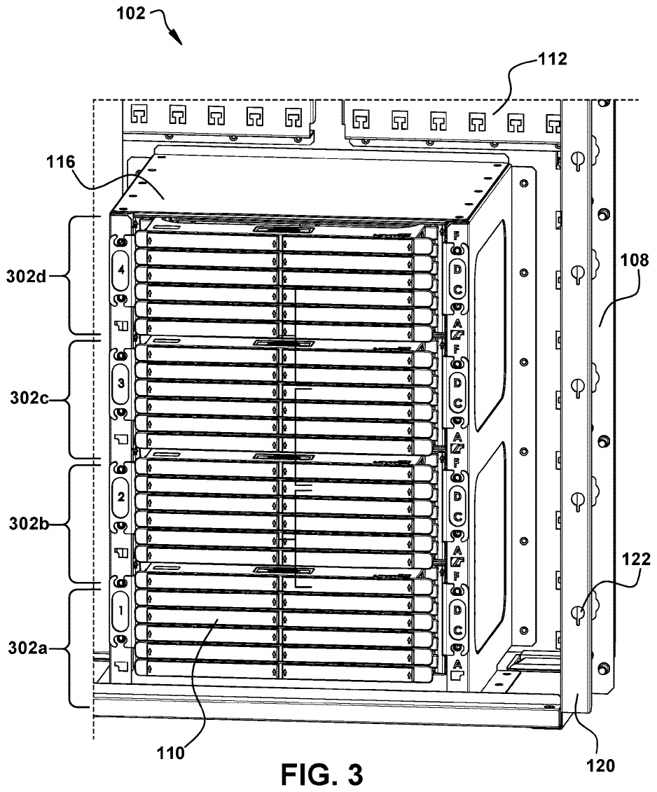

FIG. 3 is a close-up view of the subframe 116 and fiber optic trays 110. In the illustrated example, the subframe 116 holds 24 fiber optic trays 110 arranged vertically. The fiber optic trays 110 are grouped into four decks 302a through 302d, with six trays 110 per deck 302. Decks 302a through 302d are identified as Deck 1 through Deck 4, respectively, with Deck 1 (302a) being the lower-most deck and Deck 4 (302d) being the upper-most deck. Within a given deck 302, the six fiber optic trays 110 are identified as Tray A through Tray F, with Tray A being the lower-most tray in the deck 302 and Tray F being the upper-most tray.

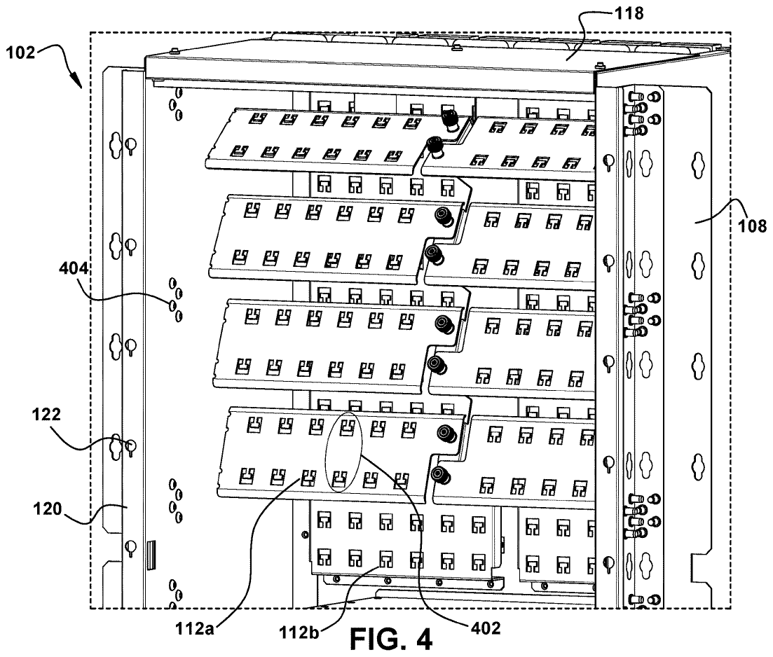

As can be seen in FIGS. 1 and 2, a number of trunk mounting plates 112 are installed in the enclosure 102 above the subframe 116 and fiber optic trays 110. FIG. 4 is a close-up view of the trunk mounting plates 112. The enclosure 102 houses two layers of trunk mounting plates 112—a set of front trunk mounting plates 112a mounted in front of the rear wall of the enclosure 102 and a set of rear trunk mounting plates 112b mounted on the rear wall of the enclosure 102 behind the front trunk mounting plates 112a. Each front trunk mounting plate 112a is installed in the enclosure 102 such that the trunk mounting plate 112a is slanted relative to the rear wall of the enclosure 102a, with the bottom edge of the trunk mounting plate 112a oriented nearer to the front of the enclosure 102 than the top edge of the trunk mounting plate 112a. This slanting can assist in directing fiber optic trunks toward the openings at the top of the enclosure 102. In the illustrated example, the enclosure 102 comprises eight front trunk mounting plates 112a mounted in a 2×4 arrangement, with four horizontally arranged pairs of plates 112a mounted in a vertical arrangement. The rear trunk mounting plates 112b are mounted in a similar 2×4 arrangement behind the front trunk mounting plates 112a. In some embodiments, the rear trunk mounting plates 112b can be mounted on the rear wall of the enclosure 102 such that the rear trunk mounting plates 112b are not slanted relative to the rear wall (that is, the rear trunk mounting lates 112b are mounted to be substantially parallel with the rear wall) or are slanted at a smaller angle relative to the rear wall than the front trunk mounting plates 112a.

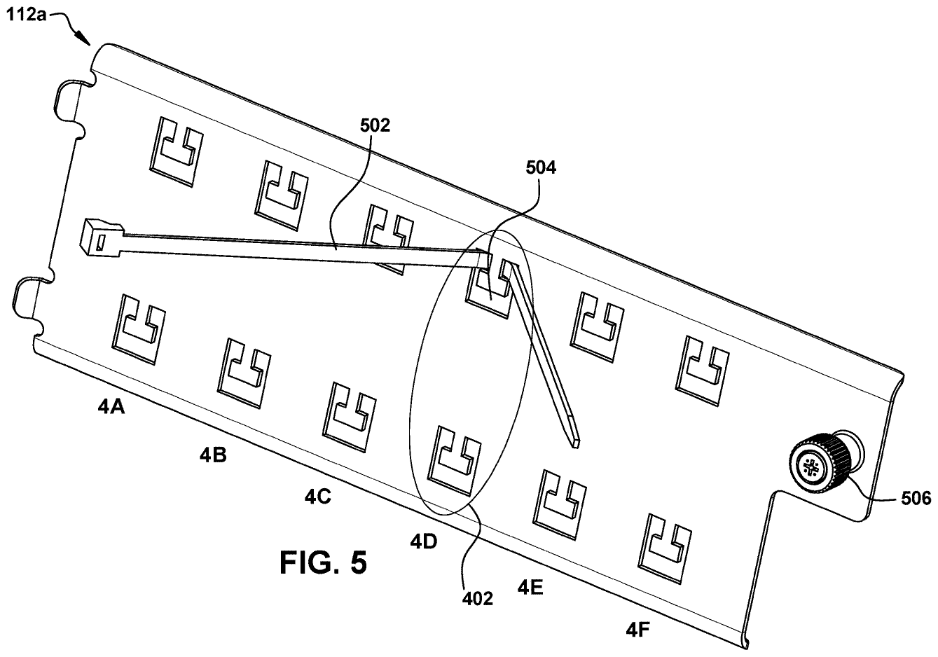

FIG. 5 is a view of a single front trunk mounting plate 112a. Each trunk mounting plate 112 comprises six trunk mounting points 402, each comprising an upper and lower pair of mounting holes 504. Each mounting hole 504 comprises a T-shaped formation that protrudes into the hole 504, around which a zip tie 502 or another attachment mechanism can be threaded. One or more fiber optic trunks 114 entering the enclosure 102 via the brushes 104 on the top of the enclosure 102 can be anchored to each trunk mounting point 402 using mounting holes 504 and zip ties 502. Trunk mounting plates 112a are removable from the enclosure 102 by unscrewing mounting screws 506.

Each trunk mounting point 402 of the trunk mounting plates 112a corresponds to a specific tray 110 within the subframe 116. In the example depicted in FIG. 5, the six trunk mounting points 402 correspond to tray 4A (tray A of Deck 4) through tray 4F (tray F of Deck 4), respectively. After a fiber optic trunk 114 that has entered the enclosure 102 (e.g., through the brushes 104 on top of the enclosure) has been anchored to a tray-specific mounting point 402 on a trunk mounting plate 112a, bundles or loops of optical fibers from the trunk 114 can then be routed to the fiber optic tray 110 corresponding to the trunk mounting point 402. The locations of the trunk mounting plates 112 and their corresponding trunk mounting points 402 are designed such that the routing distance from each trunk mounting point 402 to its designated fiber optic tray 110 is equal or substantially equal for all trunk mounting points 402 and their corresponding trays 110. This can simplify the installation and routing of optical fibers from the trunk mounting points 402 to the fiber optic trays 110 by allowing the fiber bundles from the anchored fiber optic trunks 114 to be cut to a standard length from the trunk mounting points 402 for all fiber optic trunks 114. This arrangement also allows associated materials, such as woven mesh socks for covering the bundles from the trunk mounting points 402 to the trays 110, to be pre-cut to a standard length for all bundles.

Rear trunk mounting plates 112b can be used for anchoring larger and stiffer fiber optic trunks 114 that are either passing through the enclosure 102 or are to be furcated within the enclosure 102. These larger trunks 114 can enter the enclosure 102 from the top or the bottom. When trunks 114 are furcated into smaller, more flexible bundles of fibers, the smaller bundles can be mounted on the trunk mounting points 402 of the front trunk mounting plates 112a as described above. The bundle of fibers can be looped over the top of the trunk mounting plate 112a and be mounted and directed to the tray 110 in substantially equal length loops, as also described above.

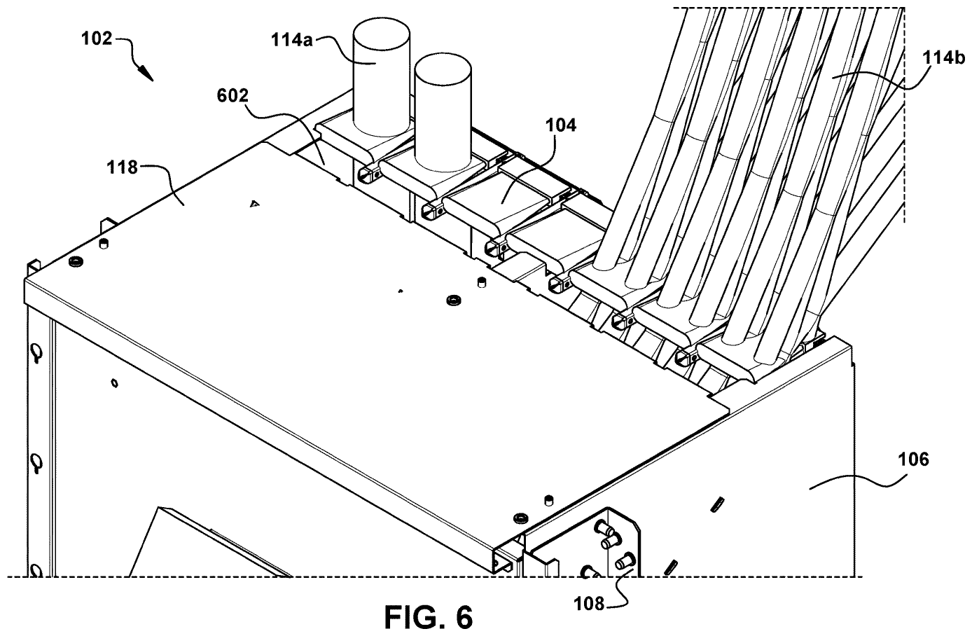

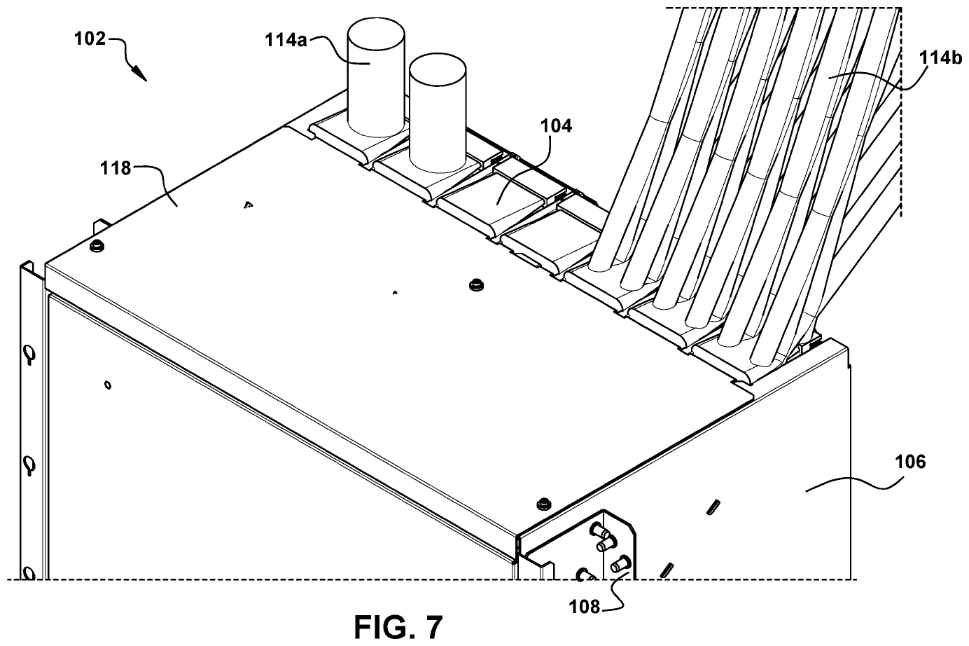

FIG. 6 is a top view of the enclosure 102 illustrating entry of fiber optic trunks 114 into the enclosure 102. Trunks 114 can enter and exit the enclosure 102 through brushes 104 with flexible bristles, which extend across openings 602 on the top side of the enclosure 102. A removable lid 118 is attached to the top of the enclosure 102 and, once unscrewed, can be slid away from the openings 602 or otherwise removed to allow trunks 114 to be laid into respective brushed openings 602. The lid 118 can then be moved back to its home position to close the openings 602. FIG. 7 is another top view of the enclosure 102 depicting the lid 118 returned to the home position. As shown in FIGS. 6 and 7, a single brushed opening 602 can receive a single fiber optic trunk (e.g., trunk 114a) or multiple smaller trunks (e.g., trunks 114b).

Openings 602 may be small enough (e.g., 50 millimeters×50 millimeters) that a hand cannot reach through to touch the enclosure contents. Openings 602 are also resistant to manual enlargement from the outside of the enclosure 102.

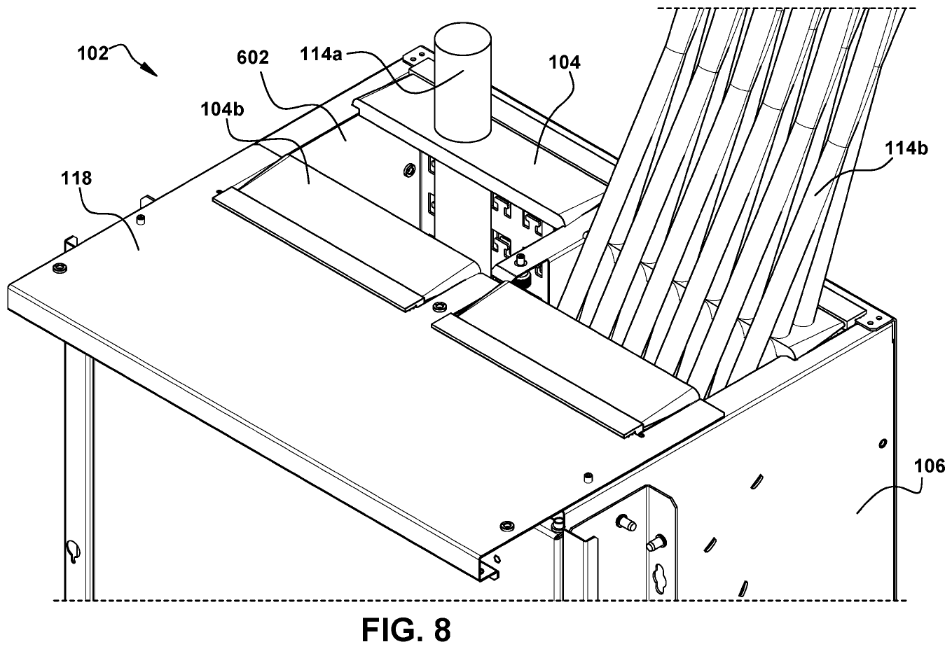

FIG. 8 is a top view of the enclosure 102 in which an alternative trunk entry design is used. Whereas the example illustrated in FIG. 7 comprises seven openings 602 and associated brushes 104, the design illustrated in FIG. 8 comprises two wider openings with associated brushes 104a formed on the main enclosure body 106. Two additional brushes 104b are also attached to the edge of the lid 118 facing brushes 104a. This design yields a larger access area through which the fiber optic trunks 114 can enter the enclosure 102.

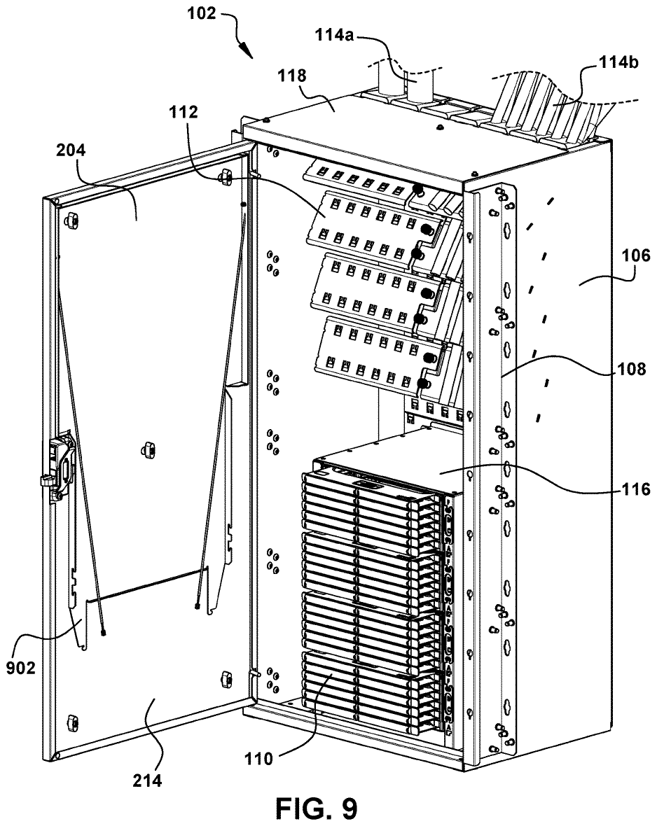

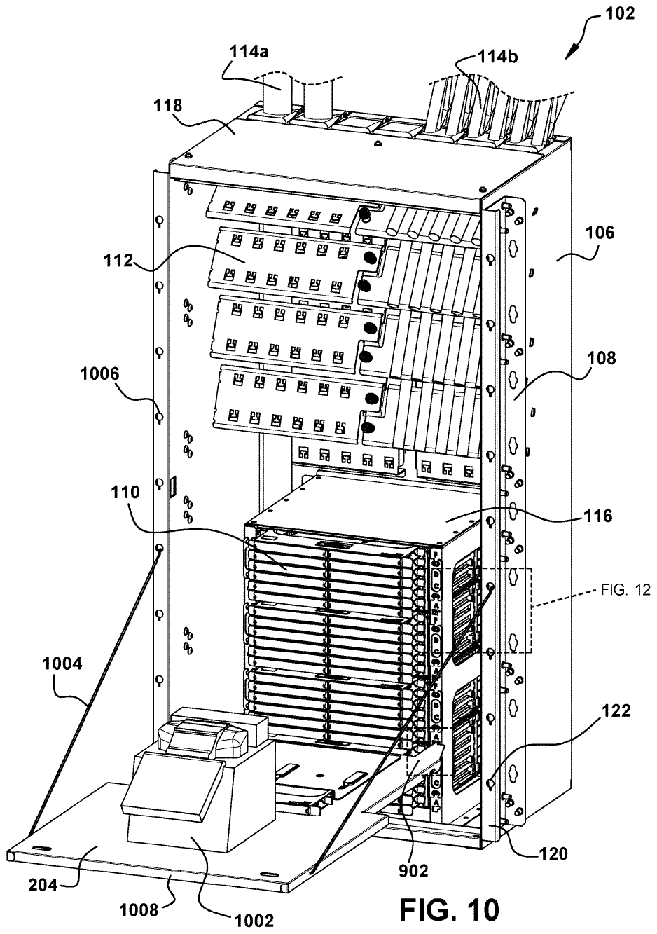

Enclosure 102 can also include an integrated workbench 204 which can be used as a work surface for splicing or manipulating optical fibers that are to be installed in the trays 110. FIG. 9 is a perspective view of enclosure 102 with the door 214 attached, showing the workbench 204 fastened to the door 214. When not in use, the workbench 204 can be mounted on the inside surface of the door 214 of the enclosure 102. When needed as a work surface to assist with splicing and manipulation of optical fibers near the trays 110, the workbench 204 can be removed from the door 214 and installed on the subframe 116. FIG. 10 is a view of the enclosure 102 depicting the workbench 204 installed in the subframe 116. In the illustrated embodiment, the subframe 116 includes mounting features that allow the workbench 204 to be selectively installed directly below any of the four decks 302 of the subframe 116 (see FIG. 3). Installers may choose to install the workbench 204 below the deck 302 whose fiber optic trays 110 will be worked on. While installed in the subframe 116, the workbench 204 can support a fiber optic splicer 1002 or other devices that the installer may wish to use while working on the optical fibers in the trays 110.

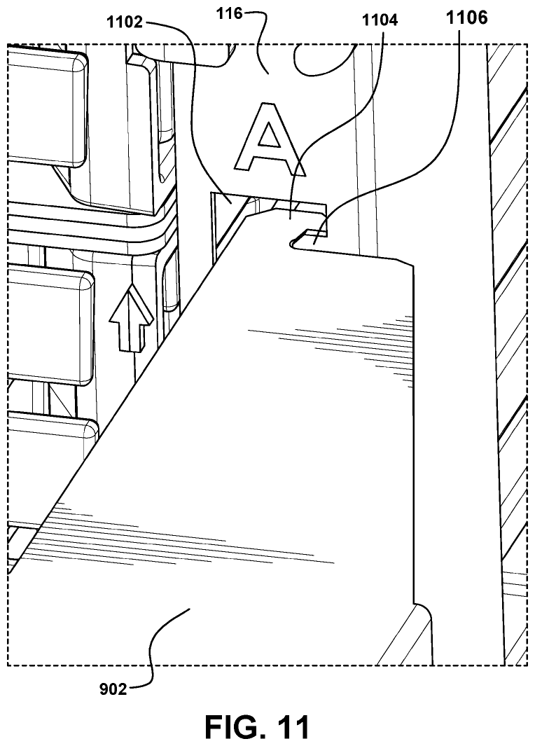

The workbench 204 comprises a flat surface with two hooked mounting arms 902 extending from one edge of the workbench 204. To install the workbench 204 into the subframe 116, the hooked mounting arms 902 can be inserted into mounting holes formed on either side of the deck 302. FIG. 11 is a close-up view of one of the hooked mounting arms 902 inserted into a right-side mounting hole 1102 of the subframe 116. The upper portion of mounting hole 1102 is wider than the lower portion, with the width of the mounting hole 1102 stepping down from the greater width to the lower width part way down the height of the mounting hole 1102. The hook 1104 at the end of the mounting arm 902 can be inserted through the wider top portion of the mounting hole 1102, then slid downward to the lower portion, locking the hook 1104 behind the step 1106 formed by the transition from the wider portion to the narrower portion of the mounting hole 1102. Workbench 204 may optionally be mounted upside down so that the workbench's stiffening walls 1008 point upward, which can prevent optical components and tools from rolling off the sides of the workbench 204.

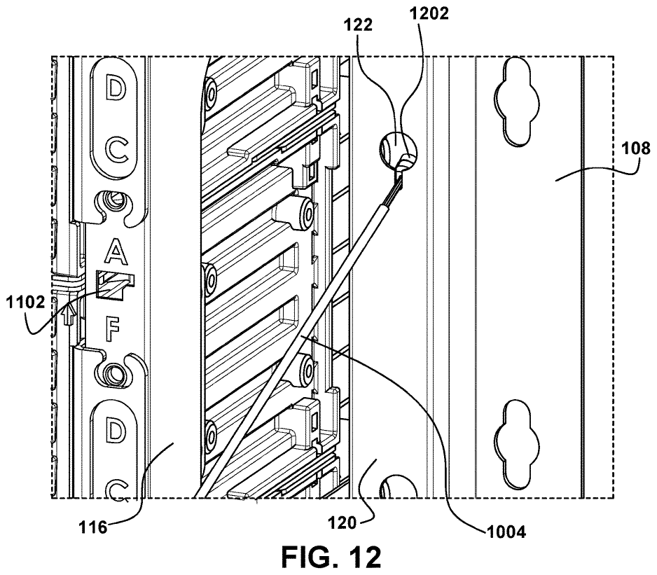

Returning to FIG. 10, the workbench 204 is further supported by a pair of cables 1004 which are anchored to the two side edges of the workbench 204, respectively, near the front edge of the workbench 204 (that is, the edge facing away from the enclosure 102 while the workbench 204 is installed in the subframe 116). The free ends of these cables 1004 can be inserted into teardrop holes 122 formed through left and right sidewalls 120 on the front of the enclosure's main body 106. FIG. 12 is a close-up view of one of the teardrop holes 1006 with the end of a cable 1004 inserted. With the mounting arms 902 of the workbench 204 installed in the subframe 116, a button 1202 or other type of connective feature crimped to the end of each cable 1004 can be inserted into respective left and right teardrop holes 122 corresponding to the deck 302 in which the workbench 204 is being installed. The cables 1004 can then be lowered into the teardrop features on the bottom of each teardrop hole 122, positioning the buttons 1202 behind the lower edges of the holes 122 and anchoring the cables 1004 to the left and right sidewalls 120.

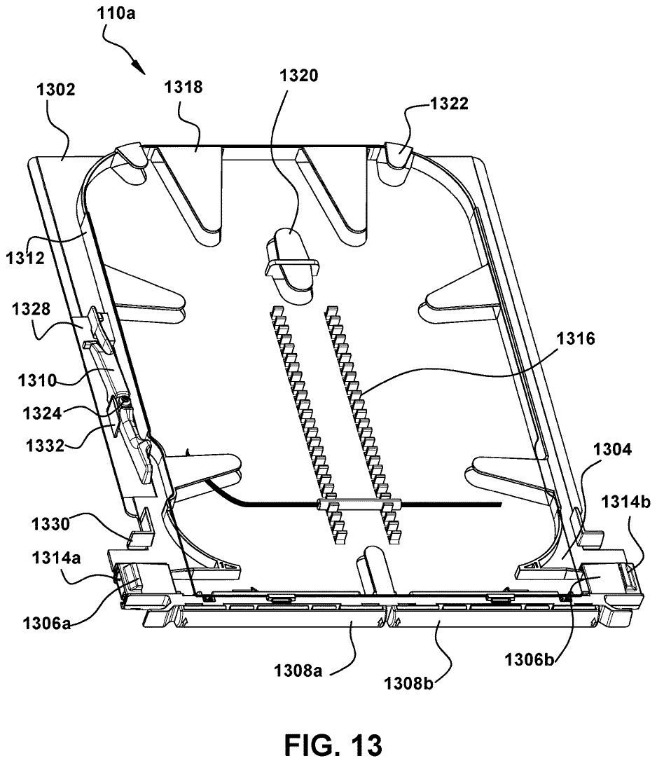

Substantially any type of fiber optic tray 110 can be installed in subframe 116. FIG. 13 is an example splice tray 110a that can be installed in the subframe 116 and used to hold spliced optical fibers. Some embodiments of splice tray 110a can comprise a base tray 1302, a cover lid 1304, two mesh sock housing caps 1306a and 1306b, two magnifying lenses 1308a and 1308b, and a latch 1310.

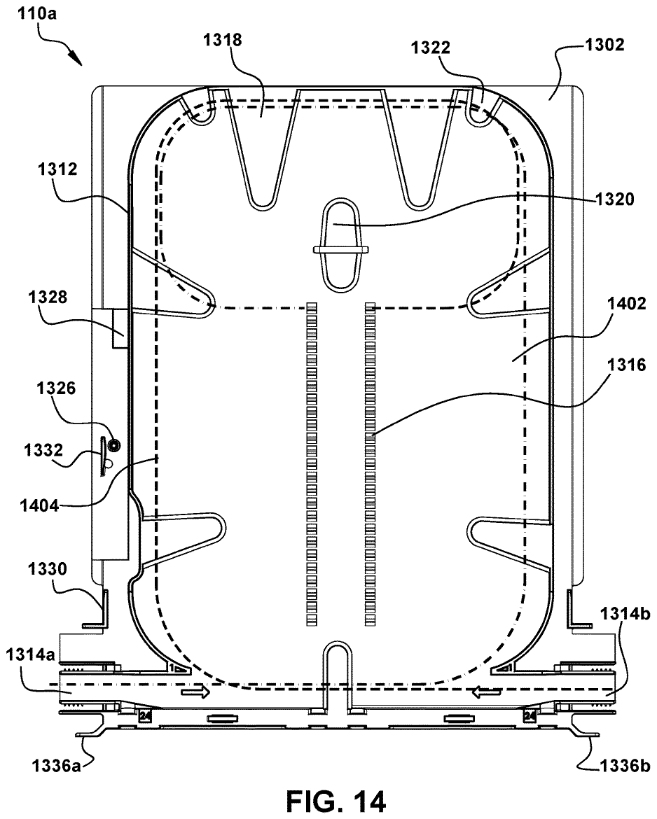

FIG. 14 is a top view of base tray 1302, which is structured to facilitate fiber routing along an internal path defined by a vertical sidewall 1312. The routing path extends between an entrance point 1314a, an exit point 1314b, and a plurality of splice sleeve holders 1316. Incoming optical fibers are introduced into the base tray 1302 through entrance point 1314a, which is positioned on one side of the front portion of the tray 110. The fibers are routed laterally across the front section of the tray 110a toward the rear of the tray 110a and terminate at the splice sleeve holders 1316 (e.g., along pathway 1402). Outgoing fibers exit the splice sleeve holders 1316 on the opposite side and are routed rearward within the tray 110a (e.g., along pathway 1404). These fibers are then directed toward the front side of the tray 110a on the incoming side (e.g., along pathway 1404) and subsequently routed across the front side of the tray 110a to exit point 1314b disposed opposite the entrance point 1314a. This arrangement allows the tray 110a to accommodate and store excess fiber slack, allowing for future fiber re-splicing operations.

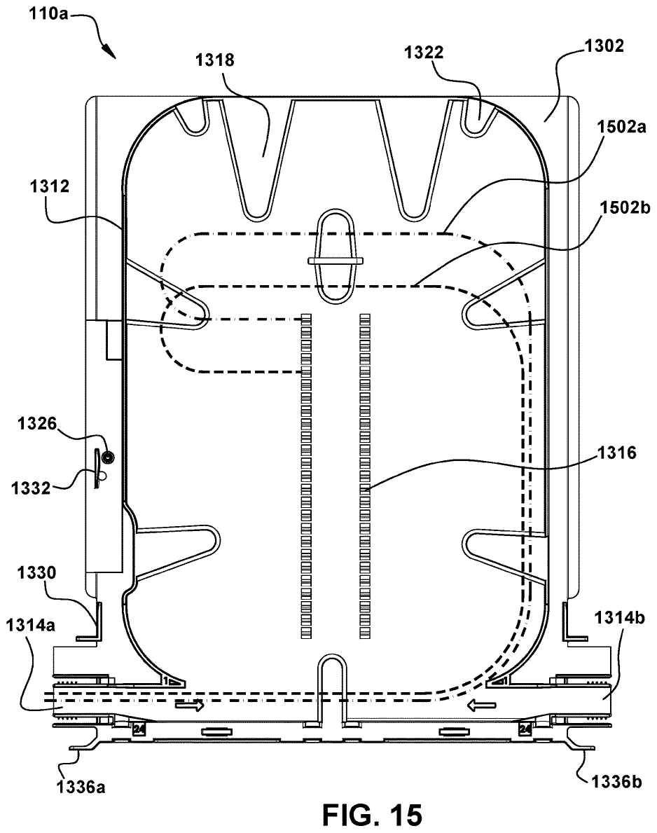

A plurality of fiber management structures 1318 are disposed around the perimeter of the vertical sidewall 1312 to retain routed fibers within the designated path. Additionally, one or more fiber managers 1320 are positioned centrally above the splice sleeve holders 1316 to secure shortened fibers on the tray 110a following re-splicing. FIG. 15 is a top view of the tray 110a illustrating the use of fiber managers 1320 to retain shortened respliced fibers 1502a and 1502b that are routed from the entrance point 1314a to the splice sleeve holders 1316.

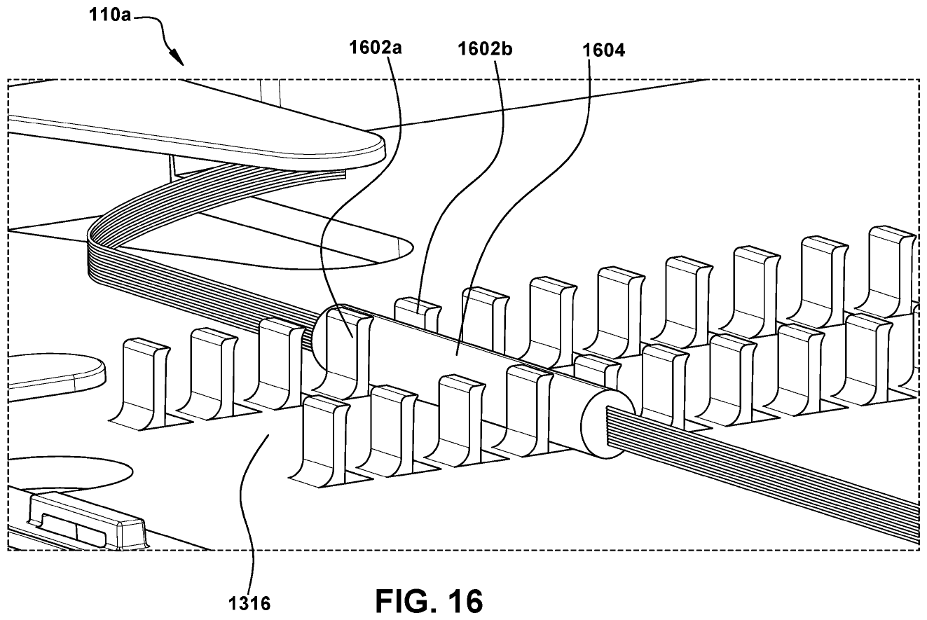

Returning to FIG. 14, the plurality of splice sleeve holders 1316 are positioned centrally and toward the front portion of the base tray 1302. This spatial arrangement facilitates routing of optical fibers from the rear of the tray 110a to the splice sleeve holders 1316 while maintaining a maximized bend radius, thereby minimizing signal loss and mechanical stress on the fibers. FIG. 16 is a close-up view of a portion of the splice sleeve holders 1316. Each splice sleeve holder 1316 comprises two pairs of angled fingers 1602a and 1602b configured to receive and retain a splice sleeve 1604. The angled fingers 1602a, 1602b are resiliently biased and function as spring elements that apply opposing forces to the splice sleeve 1604, thereby securing the sleeve 1604 firmly in place. In various embodiments, each splice sleeve holder 1316 is configured to accommodate either a single-fiber splice sleeve 1604 or a multi-fiber splice sleeve 1604.

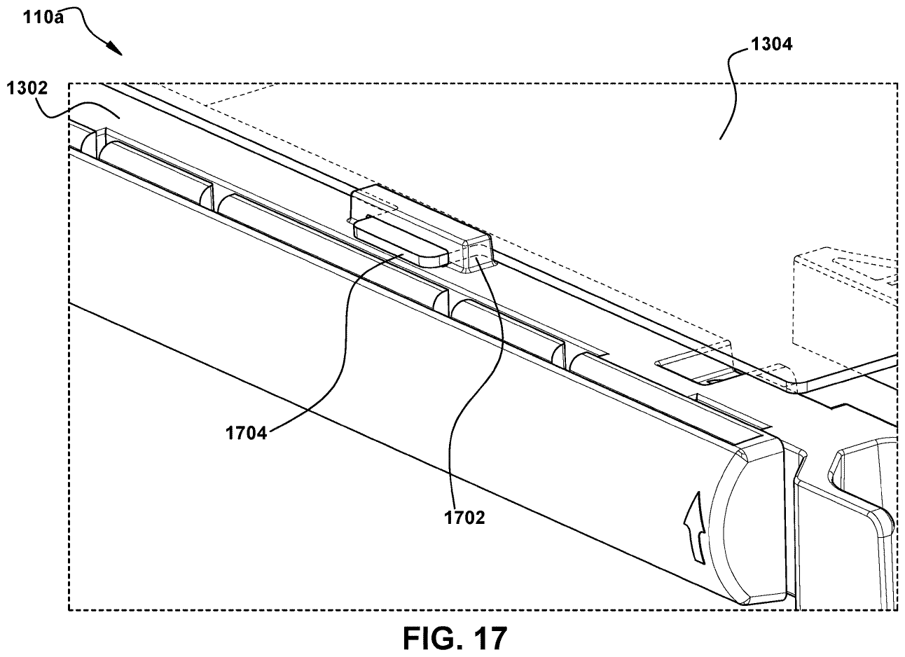

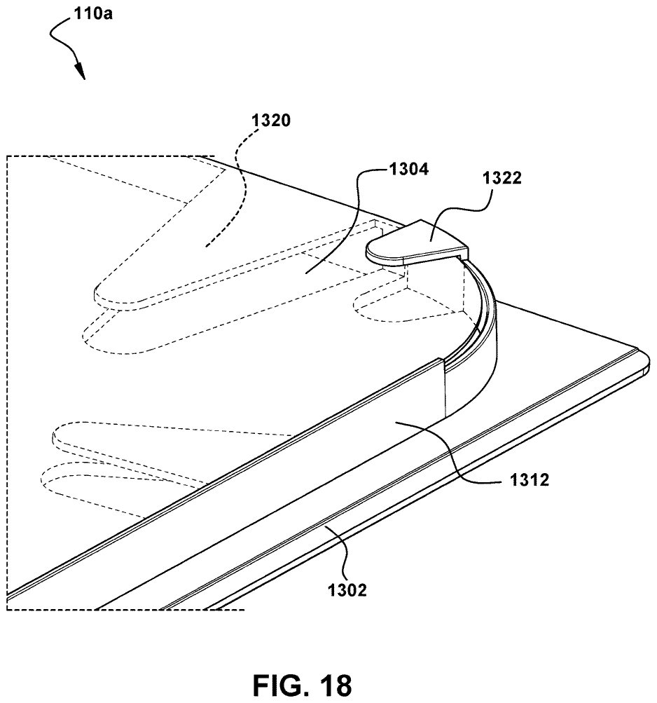

Returning to FIG. 13, when a cover lid 1304 (shown in transparency in FIG. 13) is positioned over the base tray 1302, fiber bundles disposed within the tray 110a are retained below the maximum height of the tray 110a. This configuration prevents the fibers from becoming entangled with or snagged on components of an adjacent tray during insertion or retraction of the tray assembly. The cover lid 1304 is configured to be longitudinally symmetrical, thereby allowing the lid 1304 to be installed in an invertible configuration. FIG. 17 is a close-up view of a bridge feature 1702 located at the front portion of the base tray 1302. In this embodiment, a projection 1704 extending from the cover lid 1304 is configured to slide into a corresponding aperture located beneath the bridge feature 1702. The lid 1304 is then positioned atop fiber managers 1318, 1320 and is further guided beneath additional projections 1322 extending from the tray 110a, as shown in the close-up view of FIG. 18. To secure the cover lid 1304 in position, opposing sidewalls 1312 disposed along the longitudinal edges of the base tray 1302 are configured to restrain lateral movement of the lid 1304, thereby maintaining the lid's position during operation.

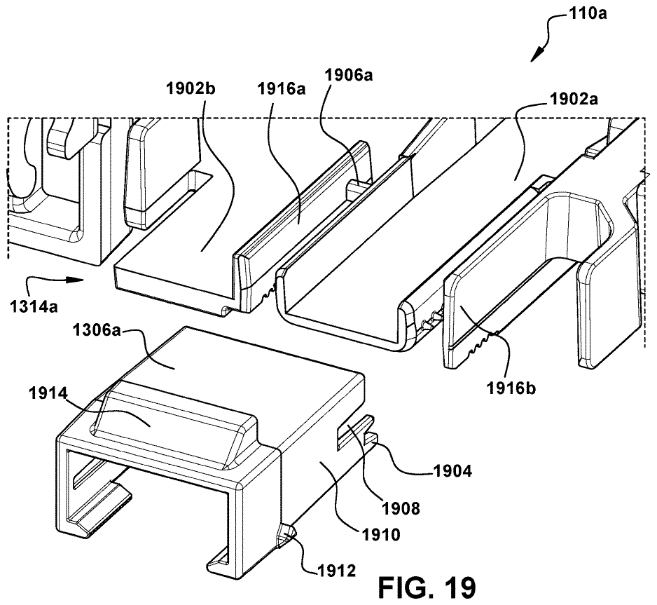

Both entrance point 1314a and exit point 1314b of splice tray 110a are located in the front portion of the tray. This arrangement avoids fibers and cable bundles outside the tray traveling into and out of the subframe 116 during tray insertion and extraction. FIG. 19 is a close-up view of the tray's entrance point 1314a. In conventional implementations, incoming and outgoing fiber bundles are typically tied up with tape and heat-shrink tubing, and secured to splice trays using cable ties. While providing firm attachment, these methods may also introduce a risk of fiber breakage due to excessive tension or mechanical stress resulting from tray movement. To enhance fiber protection and reduce the likelihood of damage, the entrance point 1314a of the splice tray 110a can comprise one or more entry channels 1902 and a mesh sock housing cap 1306a.

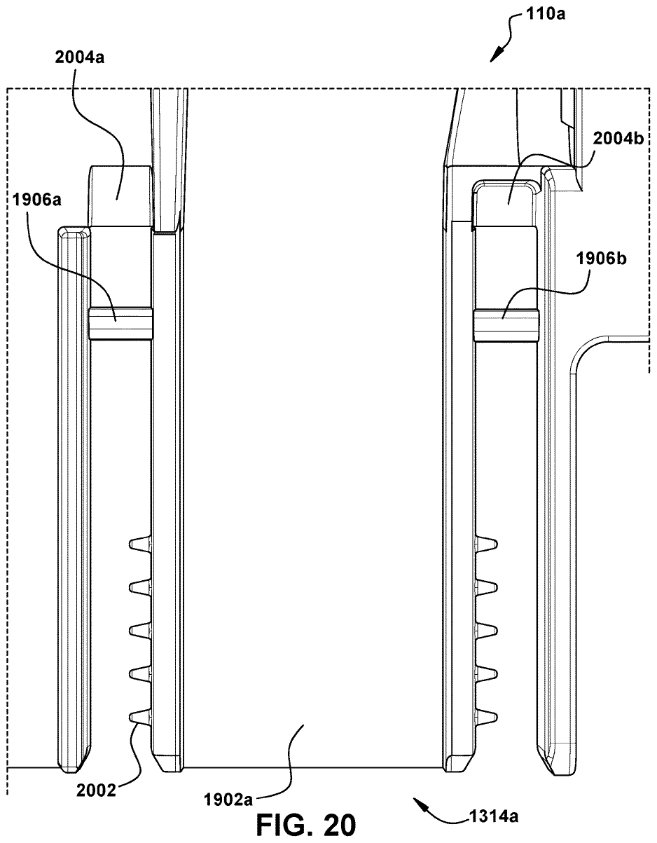

FIG. 20 is a top view of the entrance point 1314a showing the entry features in more detail. Optical fibers enclosed in mesh cable sleeving can enter or exit the tray 110a via entry channel 1902a. The sleeving is restrained by a pair of horizontal bars 1906a and 1906b disposed adjacent to the channel 1902a, which serve to limit the advancement of the sleeving and prevent interference with the tray's entrance point 1314a during the mating of housing cap 1306a. The sleeving can further be wrapped around the outer walls of the channel 1902a.

Returning to FIG. 19, housing cap 1306a, enclosing the mesh sleeving, is configured to slide over channel 1902a along and within the tray walls 1916a and 1916b by pushing the tab 1914 on top of the housing cap 1306a. As can be seen in FIG. 20, a plurality of pins 2002 disposed along the outer walls of the channel 1902a are configured to pierce the mesh sleeving under compressive force exerted by the housing cap 1306a, thereby anchoring the sleeving in place while allowing the internal optical fibers to remain freely slidable and movable within tray 110a.

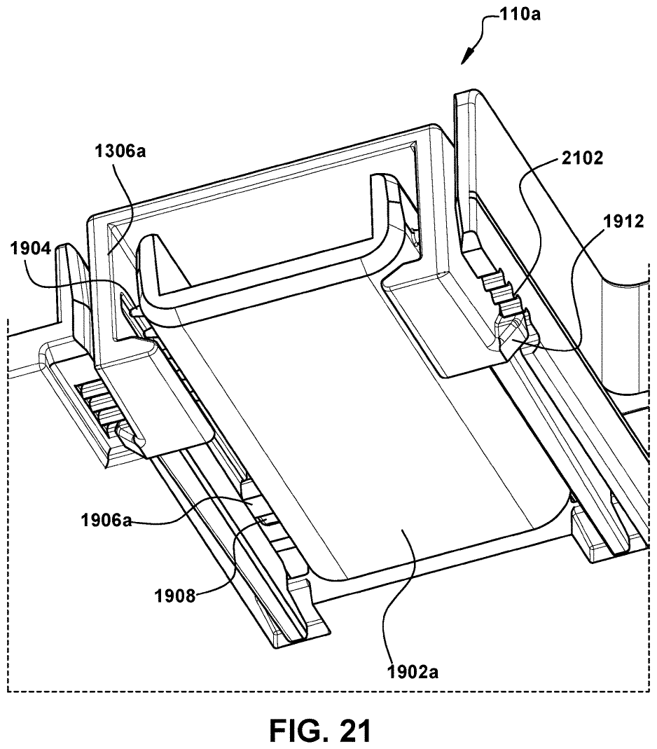

As shown in FIG. 19, slots 1908 and 1904 are formed on each of the two vertical side walls 1910 of the housing cap 1306. Slots 1908 and 1904 are formed on the rear-facing edges of the vertical side walls 1910; that is, the edges directed toward the channel 1902a when the housing cap 1306 is being installed over the channel 1902a. Slot 1908 is formed above, and is longer than, slot 1904. When the housing cap 1306a is installed over the channel 1902a, as shown in FIG. 21, the top slot 1908 of housing cap 1306a aligns with and receives the horizontal bars 1906a, 1906b, while the bottom slot 1904 aligns with and receives slanted features 2004a, 2004b (see FIG. 20) formed on the bottom surface of the tray to facilitate proper mating. During installation, the housing cap 1306a is locked into position by engagement between the locking pointers 1912 formed on the housing cap's sidewalls and corresponding grooves 2102 located beneath the tray wall structure.

Referring again to FIG. 13, a pair of magnifying lenses 1308a and 1308b are removably attached to the front portion of splice tray 110a. Each magnifying lens 1308a, 1308b is configured to snap into place via integrated retention features formed on the lens 1308a, 1308b. The magnifying lenses are further adapted to display fiber identification information, such as labeling or routing data, thereby facilitating visual inspection and fiber management during installation and maintenance procedures.

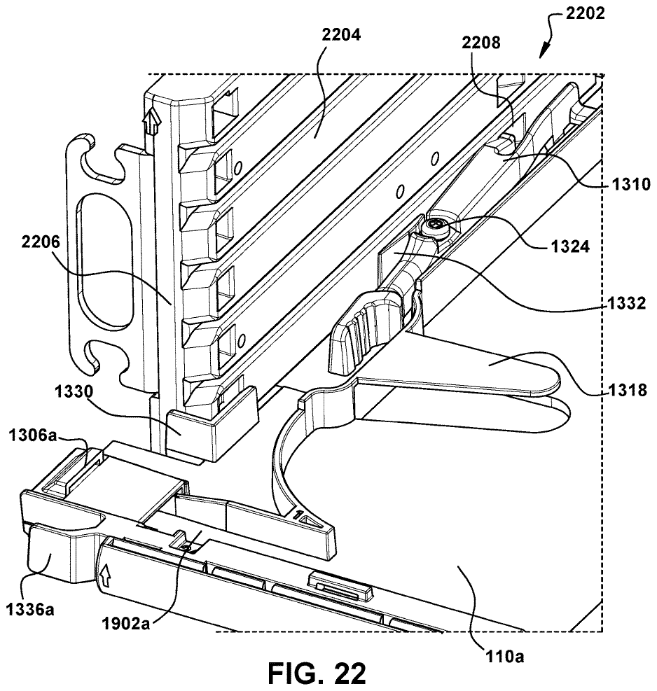

As also illustrated in FIGS. 13 and 14, a latch 1310 is mounted on a standoff structure 1326 located on the left side of splice tray 110a and is secured in place using a fastener, such as a screw 1324. The distal end of the latch 1310 is configured to engage with a rectangular protrusion 1328 formed on the tray 110a, which includes a hollowed-out cavity for anchoring the latch. FIG. 22 is a close-up view of the tray 110a inserted into a deck 2202. As can be seen in this figure, when splice tray 110a is inserted into deck 2202 along one of its slide rails 2204, the latch automatically engages with an interior wall of the deck 2202. The tray continues to travel inward until vertical L-shaped brackets 1330 disposed on both sides of the tray 110a contact the front surface of the deck walls 2206. The tray 110a is securely retained when the protruding feature of the latch 1310 engages with a corresponding square aperture 2208 formed in the wall of the deck 2202. To disengage the latch 1310, the proximal end of the latch 1310 can be manually depressed, which generates a torque that disengages the latch 1310 from the deck wall and allowing the tray 110a to be removed from the deck 2202. This action generates a torque that disengages the latch 1310 from the deck wall. To prevent excessive mechanical stress or potential damage to the standoff structure 1326 during this operation, a vertical wall 1332 adjacent to the latch 1310 provides further support to the pressed latch 1310. Upon disengagement, the tray 110a can be withdrawn from the deck 2202 by pulling on the pulling tabs 1336a, 1336b located on both sides of the front edge of the tray 110a.

When optical fibers are routed from a tray entrance or exit to the splice sleeve holder, it may be unavoidable for fibers to cross one another. This uncontrollable fiber cross-over can make fiber management difficult in the case of flat fiber ribbon cables, since these ribbon cables must be rotated from their vertical position to their horizontal position while crossing other fibers, which requires extra space for the transition in a space-limited tray. The horizontal position of these ribbon cables also limits the bendability of the fibers that make up the ribbon cable.

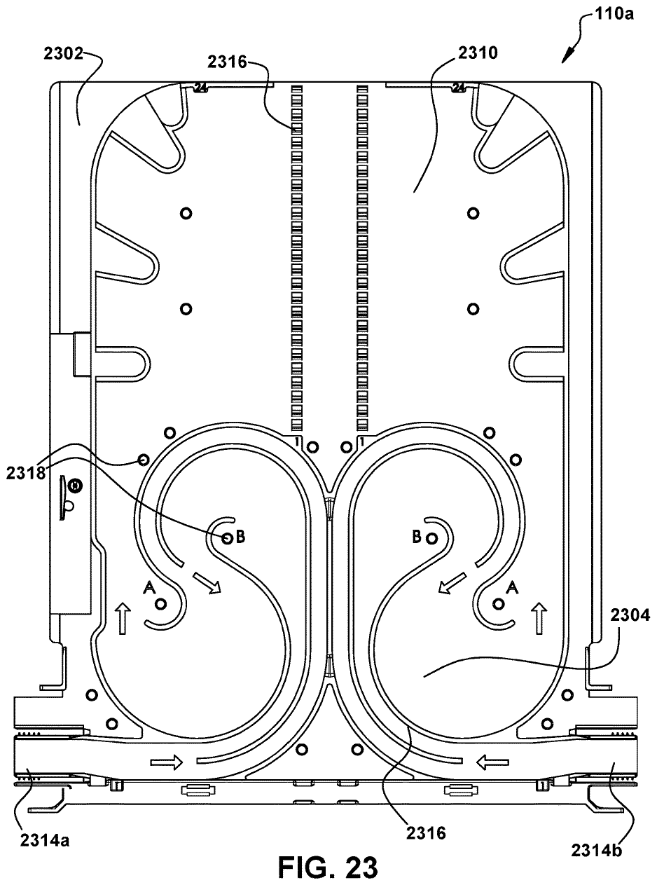

FIG. 23 is a top view of an embodiment of splice base tray 2302 that addresses these issues. As can be seen in this figure, some embodiments of the splice base tray 2302 can comprise two serpentine fiber paths 2304 that extend from the tray's entrances 2314 to the fiber fan-in/fan-out areas 2310. These serpentine paths 2304 allow the fibers to be routed to the splice sleeve holders 2316 without requiring the fibers to cross over one another, allowing fiber ribbon cables to remain in their vertical positions throughout the route for easy bending. The entrances 2314 of this embodiment of the base tray 2302 are also configured to utilize the same mesh sock securing mechanism as employed in the previously described embodiment. Also similar to the previously described embodiment, this mechanism includes a plurality of extruded pins 2002 and corresponding housing caps 1306, which are operable to anchor fiber mesh sleeving onto the entry channels. The formations of the serpentine paths 2304, tray entrances 2314, and fiber fan-in/fan-out areas 2310 are substantially symmetrical about the axis of the splice tray 2302.

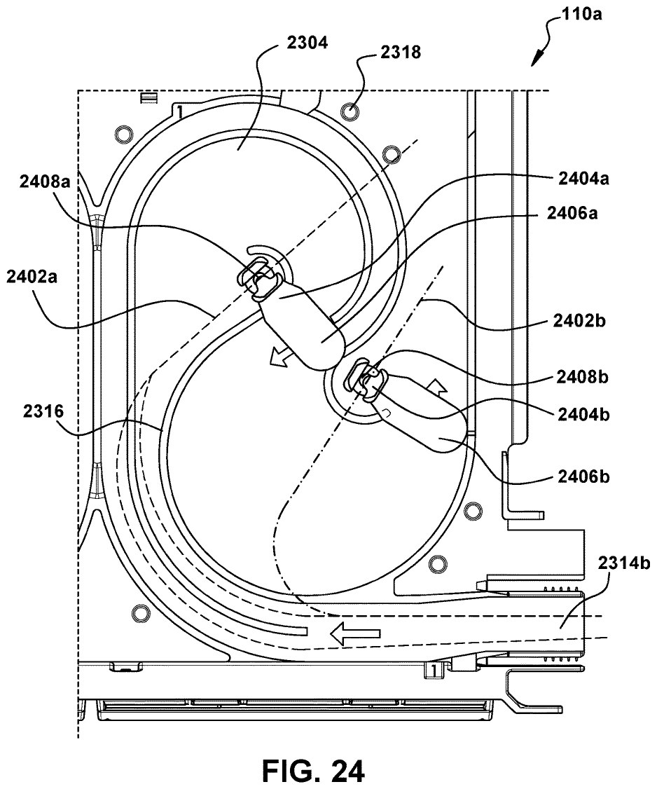

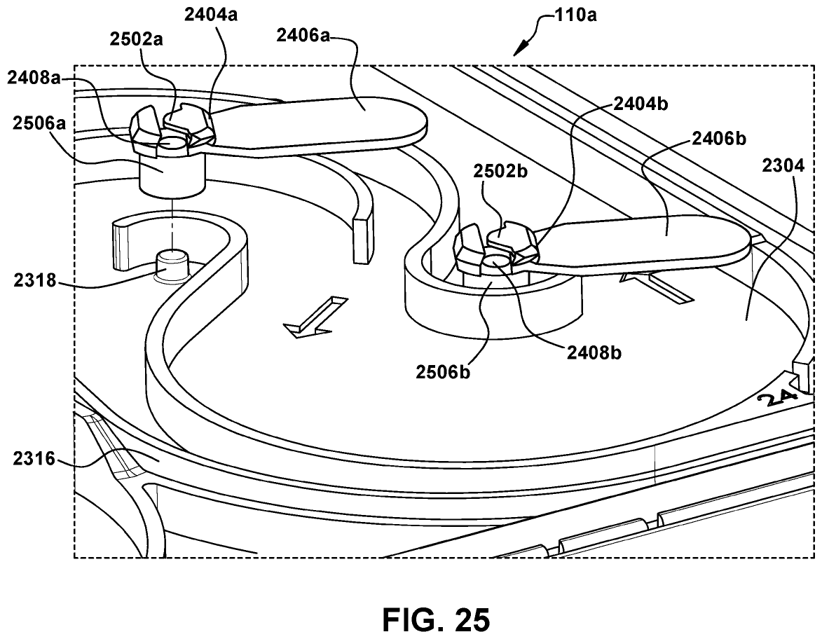

Conventionally, if fibers are severed or damaged and require resplice, the shortened fiber strands on a fiber optic tray 110 would be required to loop in a smaller radius and cross over the top of other fibers. By contrast, embodiments of the splice tray 2302 support routing of fibers through flyover paths, which allows routing of flyover fibers to the splice sleeve holders 2316 to be easily managed. FIG. 24 is a close-up view of the right-side serpentine path 2304 illustrating flyover paths 2402a and 2402b made possible by the design of splice tray 2302. In general, there are two available flyover paths 2402a and 2402b on each of the left and right sides of the splice tray 2302. The first flyover path 2402a is facilitated by a fiber manager component 2404a, and the second flyover path 2402b is facilitated by another fiber management component 2404b. FIG. 25 is a closeup view of the fiber manager components 2404a and 2404b mounted on the splice tray 2302. As can be seen FIGS. 23-25, multiple pegs 2318 are formed on the base of the splice tray 2302. Each fiber manager component 2404 comprises a hollow cylinder 2506a, 2506b that can be snapped onto a selected peg 2318. Once mounted on a peg 2318, the fiber manager component 2404 is rotatable about the peg 2318 (or about an axis of the hollow cylinder 2506). Each fiber management component 2404a, 2404b also has a flyover channel 2408a, 2408b formed on the top of the hollow cylinder 2506a, 2506b (that is, the side opposite the side in which the peg 2318 resides) and an elongated fiber holding tab 2406a, 2406b that extends substantially perpendicular to the axis of the cylinder 2506. In some embodiments, the top of the cylinder 2506 can have a mushroom head design with two flattened edges to allow the fiber manager components 2404 to be gripped easily.

Returning to FIG. 24, if installers cannot route shortened incoming optical fibers through the entirety of the serpentine path 2304, but instead need to traverse through flyover path 2402a which bypasses a portion of the serpentine path 2304, the fibers can be slid into and routed through the channel 2408a formed on top of the fiber manager component 2404a. A small fiber holding tab 2502a (see FIG. 25) formed over the channel 2408a can hold the fibers in place in the channel 2408a. This yields a shorter route from the tray entrance 2314 to the splice sleeve holders 2316 relative to traversing the entirety of the serpentine path 2304.

The second flyover path 2402b yields a still shorter route, allowing fibers to bypass the walls 2316 of the serpentine path 2304 at a point near the tray entrance 1314b, thereby bypassing the entirety of the serpentine path 2304. This path 2402b can be made possible by flying over the wall 2316 of the serpentine path 2304 near the entrance 1314b. The fibers can then be routed through channel 2408b of fiber manager component 2404b and held in place by a fiber holding tab 2502b (see FIG. 25) on the fiber manager component 2404.

Some fiber optic trays include fixed and inflexible fiber managers along the fiber route. These fixed fiber managers can render resplicing of optical fibers difficult, particularly if a defective fiber must be removed from the fiber bundle. To address this, the fiber manger components 2404 of splice tray 2302 can be rotated or removed to clear access to the tray's fiber paths, allowing fiber bundles, or individual fibers from the bundles, to be easily removed. Pegs 2318 on which the fiber manger components 2404 are mounted are formed at multiple locations along the serpentine path 2304, allowing installers to selectively place the fiber manager components 2404 where needed. Pegs 2318 can be sized such that friction will hold the contracting interior of the hollow cylinder 2506 of the fiber manager components 2404 in place.

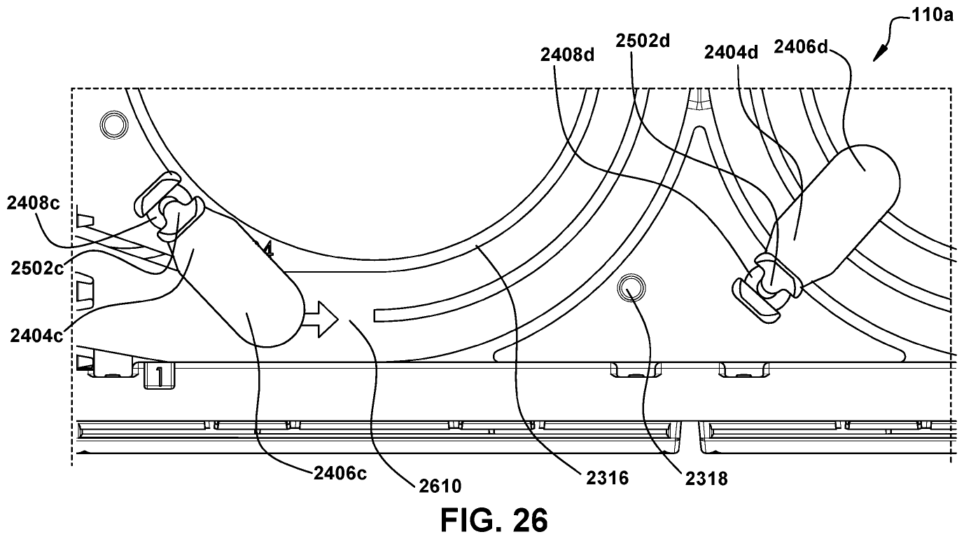

FIG. 26 is a close-up view of the front portion of the splice tray 2302 depicting two additional rotatable and removable fiber manager components 2404c and 2404d. Fiber manger components 2404c and 2404d have a structure similar to that of fiber manger components 2404a and 2404b, including an elongated flap 2406c, 2406d which can be rotated about a mounting point, a flyover channel 2408c, 2408d, and a fiber holding tab 2502c, 2502d. Each of flaps 2406c, 2406d can be oriented over a fiber optic path 2610 near an entrance 2314 of the splice tray 110a, holding the optical fibers at that portion of the fiber path 2610 in place.

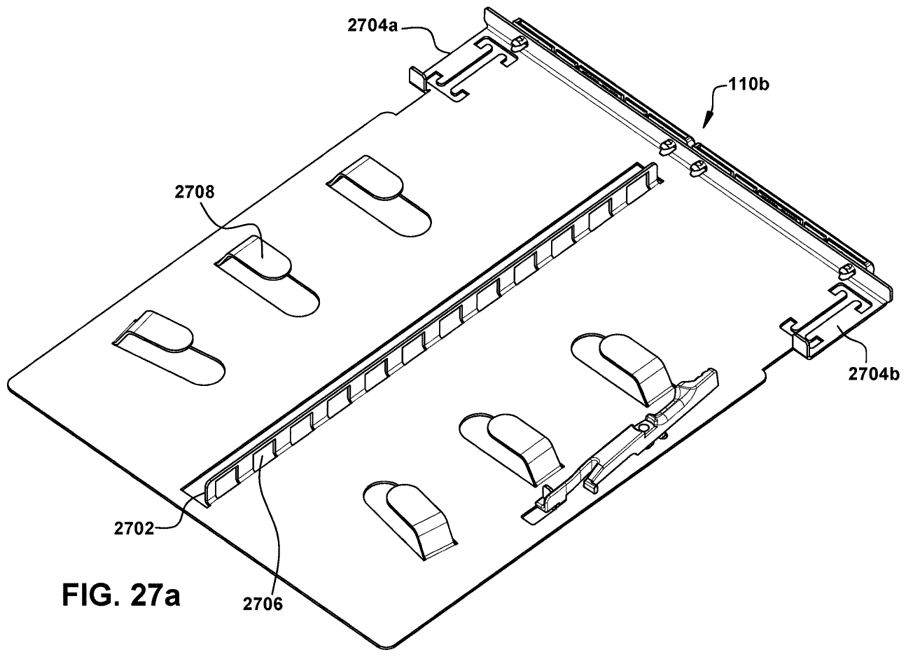

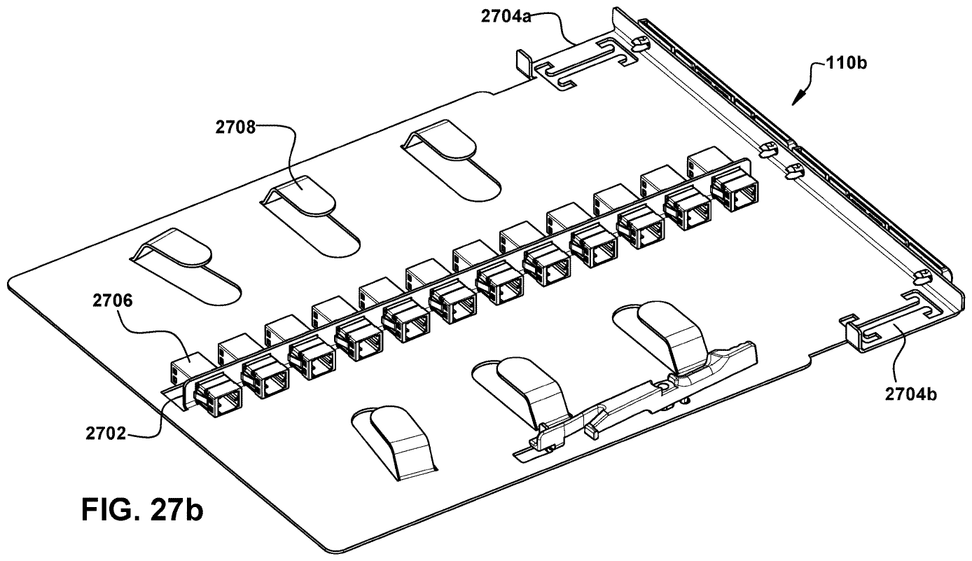

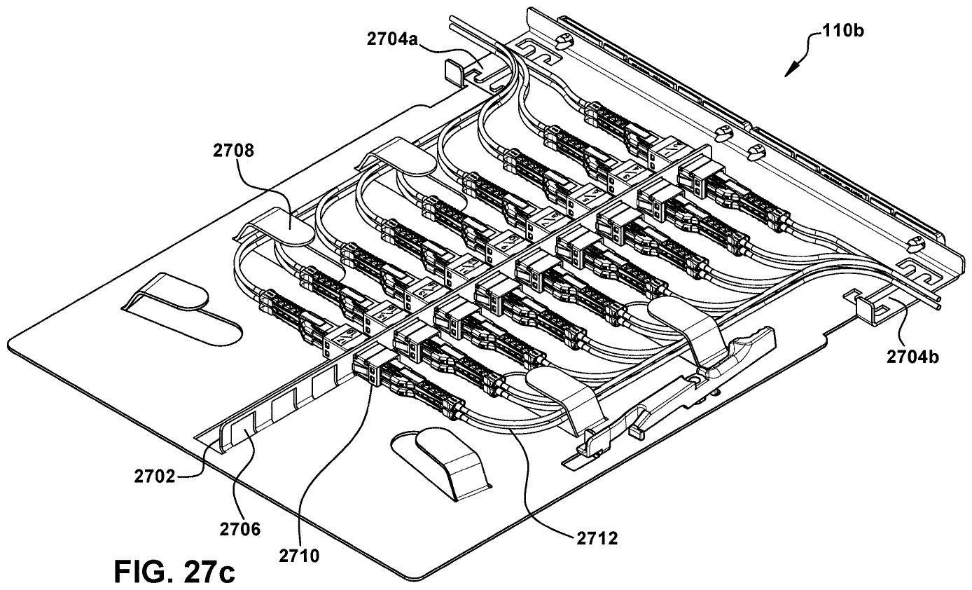

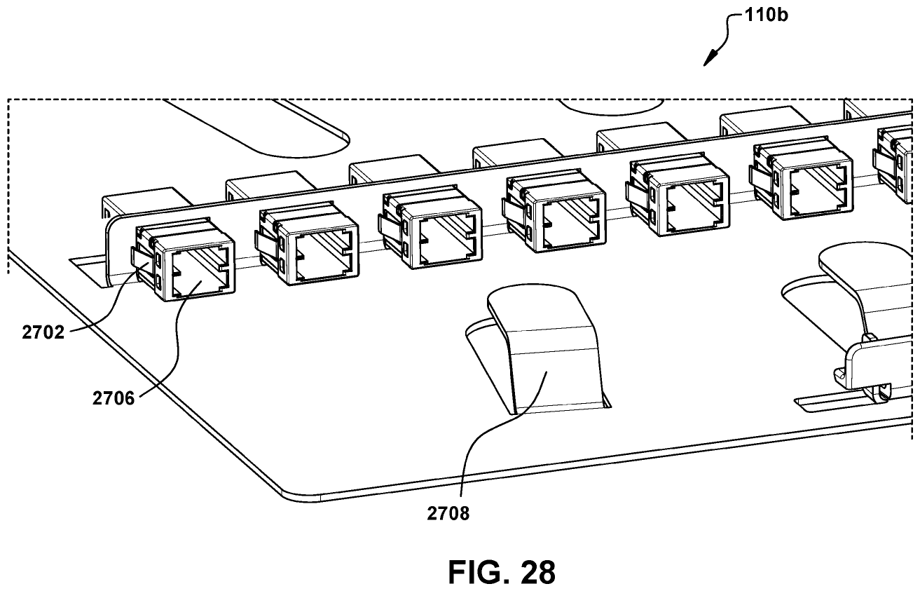

In some embodiments, the fiber optic tray 110 can also be configured as an interconnect tray adapted to facilitate the coupling and management of fiber optic connectors, thereby enabling efficient optical signal transmission between interfacing components. FIG. 27a is a top view of an example interconnect tray 110b, which can be installed in the subframe 116. FIG. 27a depicts the interconnect tray 110b with adapters 2706 omitted. FIG. 27b is a top view of the interconnect tray 110b with adapters 2706 installed. In contrast to the splice tray 110a, which is designed to hold optical fibers that are connected together by splicing ends of respective fibers together, interconnect tray 110b is designed to hold optical fibers that are terminated by connectors. Accordingly, interconnect tray 110b comprises a row of adapters 2706 (or couplers) mounted on the top surface of the tray 110b. FIG. 28 is a close-up view of the interconnect tray 110b in which the adapters 2706 can be seen more closely. Each of the adapters 2706 is installed through a vertical wall 2702 that extends substantially perpendicular from the top surface of the tray 110b and that extends along the tray 110b in the lengthwise direction. The wall 2702 comprises a number of mounting adapters 2706 (12 mounting adapters 2706 in the illustrated example) in which the adapters 2706 can be inserted. FIG. 27c is a top view of the interconnect tray 110b in which fiber optic connectors 2710 have been plugged into the adapters 2706. Each adapter 2706 can receive, through each of the front and rear sides of the adapter 2706, a fiber optic connector 2710 terminated on the end of a fiber optic cable 2712. Plugging terminated fiber optic cables 2712 into both the front and rear sides of an adapter 2706 communicatively couples the two fiber optic cables 2712, with the adapter 2706 holding the two opposing cable connectors 2710 in place. A series of fiber manager tabs 2708 positioned along the edge of the interconnect tray 110b keep the cables 2712 on both sides of the adapters 2706 on the surface of the interconnect tray 110b.

Two entrances 2704a and 2704b are formed on opposing front corners of the interconnect tray 110b on either side of the row of adapters 2706. This orientation allows two fiber bundles to enter the tray 110b via the two entrances 2704a and 2704b, respectively, and individual cables of the bundles to be communicatively connected by plugging corresponding cables from the two bundles into a common adapter 2706.

In the illustrated example, adapters 2706 are depicted as Multi-fiber Termination Push-on (MTP) adapters. However, the mounting holes in the wall 2702 allow adapters 2706 to be removed and replaced with other types of fiber adapters, such as Miniature Multiple Connector (MMC) adapters. For example, the 12 MTP adapters 2706 shown in FIGS. 27a, 27b, and 28 can be replaced by 12 MMC duplex adapters, as shown in FIG. 27c.

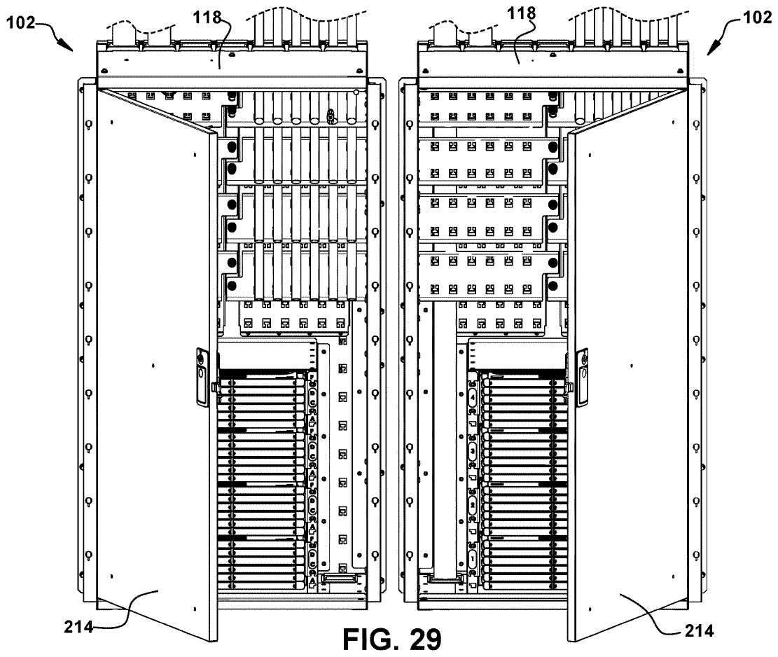

FIG. 29 depicts front views of the enclosure 102 illustrating versatility of door mounting. The door 214 of the enclosure 102 can be removed and mounted on either the left or right side of the enclosure 102. Bent pins can act as hinges at the top and bottom of the door 214. Plastic bushings on the lid 118 and on the floor of the enclosure 102 can hold the hinges and support the floor. The workbench 204 is mounted inside the door 214 such that the workbench 204 does not interfere with the trays 110 regardless of whether the door opens from the right or left side of the enclosure 102.

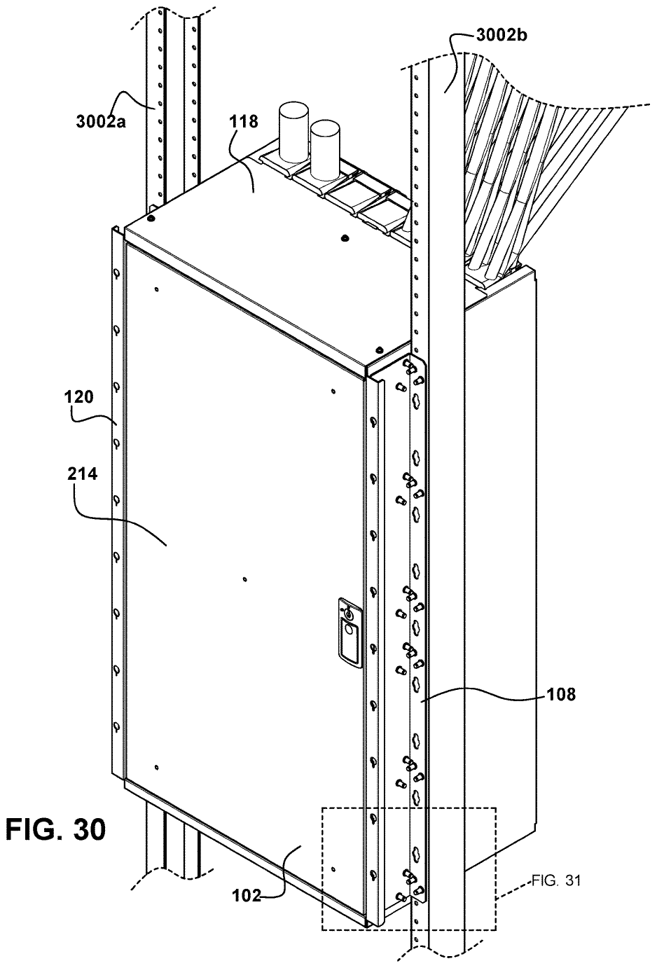

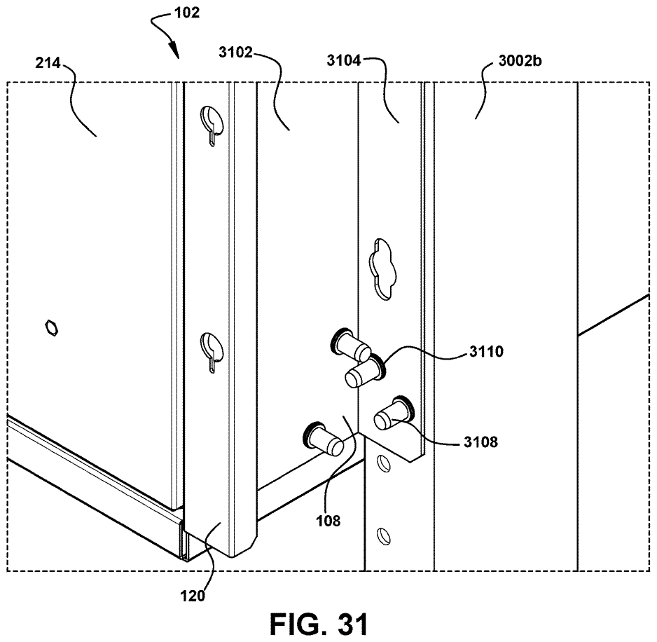

FIG. 30 is a perspective view of the enclosure 102 mounted on posts 3002a, 3002b of a rack using a mounting bracket 108 on each side. FIG. 31 is a close-up view of the lower portion of the mounting bracket 108 holding the enclosure 102 in place on post 3002b. Mounting bracket 108 comprises two mounting flanges 3102 and 3104 joined at a right angle, with mounting holes for screws 404 formed through each of the mounting flanges 3102 and 3104.

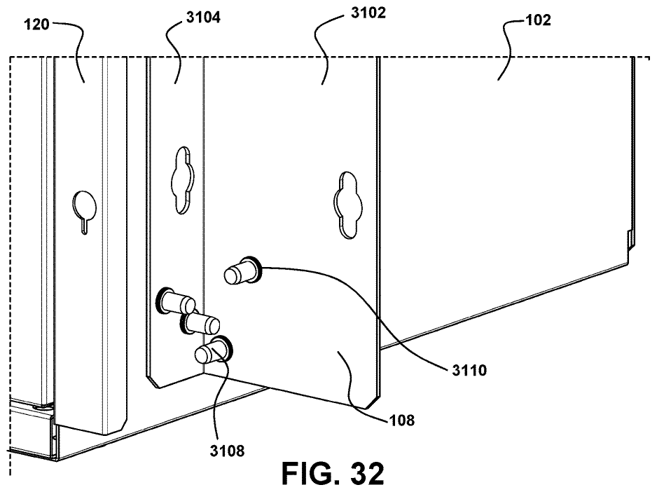

Mounting flange 3102 is wider than mounting flange 3104. In the example illustrated in FIGS. 30 and 31, wider flange 3102 is anchored to the enclosure 102 while narrower flange 3104 is anchored to the post 3002b of the rack. This arrangement can be suitable for IT-width racks. If the enclosure 102 is to be mounted to a rack having posts 3002 that are spaced further apart, such as a telecom rack, the bracket 108 can be reversed such that the narrower flange 3104 anchors to the enclosure 102 and the wider flange 3102 anchors to the post 3002. FIG. 32 is a close-up view of the lower portion of the mounting backet 108 with the narrower flange 3104 anchored to the enclosure.

Blind nuts 3110 formed on the mounting flanges 3102 and 3104 can accept screws 404 from the inside of the enclosure 202. The blind nuts 3110 cover the threads of the screws 404 to minimize snag points outside the enclosure 202. The rounded heads of the screws 404 inside the enclosure 102 (see FIG. 4) minimize snag points for the optical cabling inside the enclosure 202.

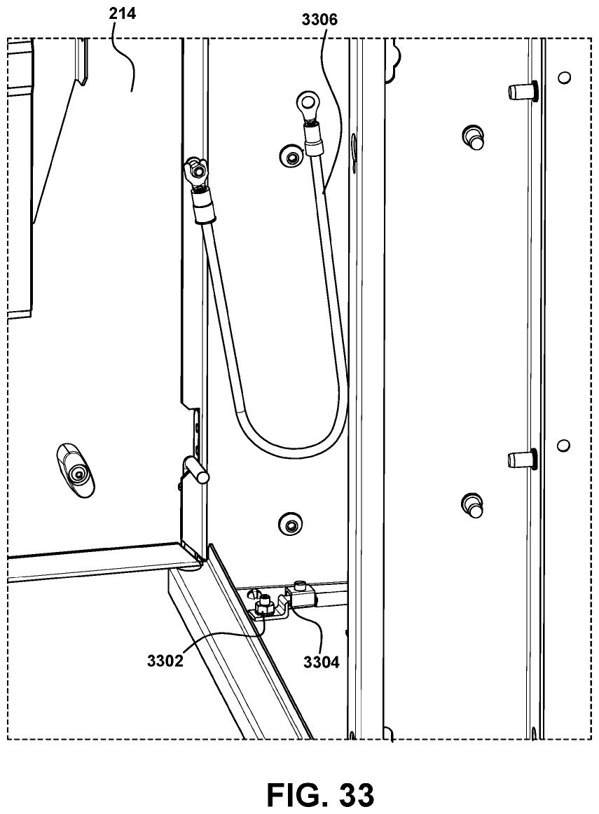

FIG. 33 is a close-up view of the lower portion of the enclosure 102 illustrating example grounding mechanisms that can be built into the enclosure. In some embodiments, a grounding lug 3302 can be installed on the floor of the enclosure 102, or on another surface of the enclosure 102. The grounding lug allows the enclosure 102 to be electrically grounded via a ground wire 3304 affixed to the lug 3302. Optionally, the door 214 of the enclosure 1020 can also be electrically grounded to the main body of the enclosure 102 via a conductive flexible copper cable 3306.

To ensure that all metal components of the enclosure 102 are electrically grounded via the grounding lug 3302, the various metal components that make up the enclosure 102 must be electrically continuous, ensuring a complete ground path from any point on the enclosure 102 to the lug 3302 via any intermediate interconnections between the metal components. In a typical scenario, some or all of the metal components of the enclosure 102 are painted and then riveted together. To ensure a reliable electrical connection between adjoining metal components, even if painted, thread-forming screws, such as trilobular screws, can be used to connect the metal components of the enclosure 102. When a thread-forming screw is screwed into the hole of a metal component, the threads of the screw penetrate through the paint layer covering the sidewalls of the hole, ensuring reliable conductive contact between the metal screw and the metal material of the component below the paint layer. Because of their metal penetration and deformation, thread-forming screws are resistant to loosening due to vibration, and can prevent moisture from entering the enclosure 102 through the fastening point.

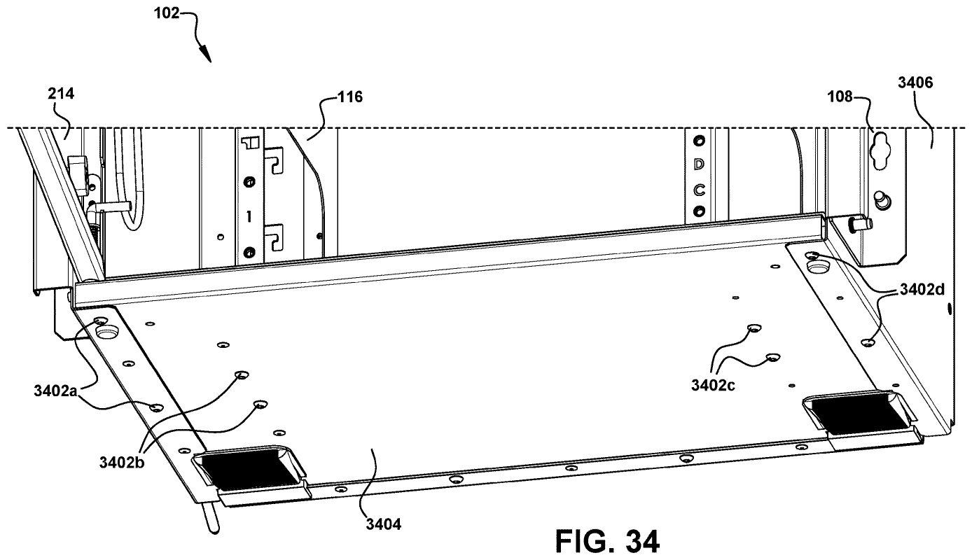

FIG. 34 is a view of the underside of the enclosure 102 indicating locations of thread-forming screws 3402 through the floor 3404 of the enclosure 102 according to one or more embodiments. In this example, a first pair of thread-forming screws 3402a and a second pair of thread-forming screws 3402d bond the floor to each of the two side walls 3406 of the main enclosure body 106, respectively. Additionally, a third pair of thread-forming screws 3402b and a fourth pair of thread-forming screws 3402c bond the floor 3404 to the two side walls, respectively, of the subframe 116.

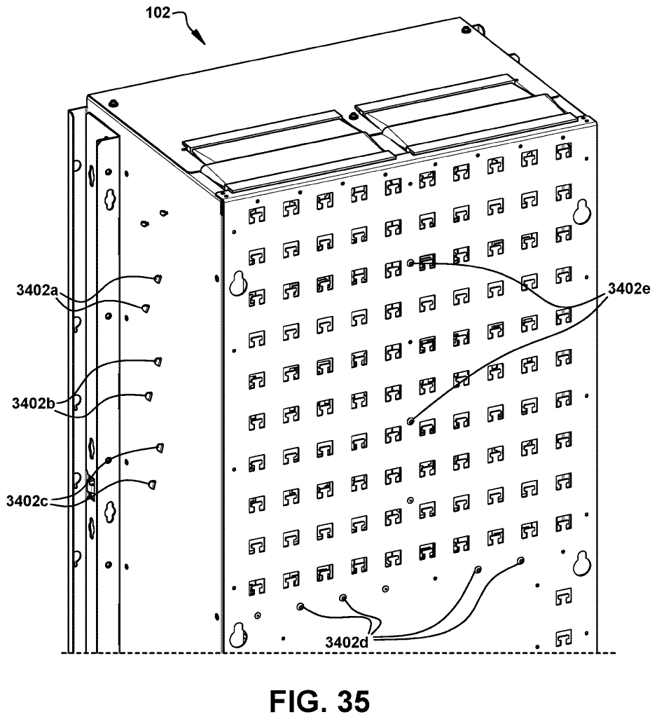

FIG. 35 is a view of the rear side of the enclosure 102 indicating locations of thread-forming screws 3402 through the rear and side walls of the enclosure 102. In this example, pairs of thread-forming screws 3402a, 3402b, and 340c bond the right-hand side wall of the enclosure 102 to respective rear trunk mounting plates 112b (not visible in FIG. 35, see FIGS. 1 and 2) mounted on the right side of the enclosure 102. Similar pairs of thread-forming screws bond the left-hand side wall of the enclosure 102 to respective rear trunk mounting plates 112b mounted on the left side of the enclosure 102. Additional sets of thread-forming screws bond the rear wall of the enclosure 102 to the enclosure's internal scaffold.

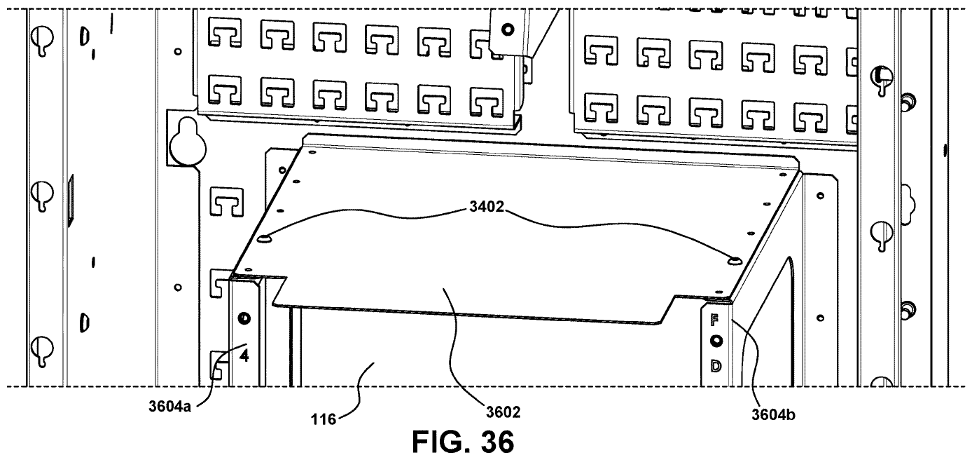

FIG. 36 is a view of the subframe 116 of the enclosure 102 indicating locations of thread-forming screws 3402 that bond the sidewalls 3604 of the subframe 116 to the subframe's lid 3602. In this example, each of the two thread-forming screws 3402 is driven through the top of the lid 3602 and through the top edge of one of the two sidewalls 3604a or 3604b of the subframe 116, thereby bonding the sidewalls 3604 to the lid 3602.

In the examples depicted in FIGS. 34-36, each thread-forming screw 3402 is screwed through aligned holes in the two metal components being bonded. The holes in both metal components have a diameter that is smaller than the diameter of the screw's threads, ensuring that the threads engage deeply with the sidewalls of the holes. This deep engagement between the threads and the holes provides reliable grounding contact between the metal components and the screw 3402, and thus reliable ground connectivity between the two metal components via the screw 3402.

Although the illustrated examples consider the use of thread-forming screws 3402, such as trilobular screws, to electrically bond the enclosure's metal components for grounding purposes, other bonding techniques are also within the scope of one or more embodiments.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A fiber optic enclosure, comprising:
an enclosure body;
one or more trunk mounting plates mounted inside the enclosure body at an angle relative to a rear wall of the enclosure body; and
a subframe below the trunk mounting plates and configured to hold fiber optic trays in a vertical arrangement.

2. The fiber optic enclosure of claim 1, wherein a trunk mounting plate of the one or more trunk mounting plates comprises multiple trunk mounting points comprising a pair of trunk mounting holes.

3. The fiber optic enclosure of claim 2, wherein a first routing distance from a first trunk mounting point, of the multiple trunk mounting points, to a first of the fiber optic trays corresponding to the first trunk mounting point is substantially equal to a second routing distance from a second trunk mounting point, of the multiple trunk mounting points, to a second of the fiber optic trays corresponding to the second trunk mounting point.

4. The fiber optic enclosure of claim 1, wherein the one or more trunk mounting plates comprise a set of front trunk mounting plates mounted in front of the rear wall of the enclosure and a set of rear trunk mounting plates mounted on the rear wall of the enclosure behind the front trunk mounting plates.

5. The fiber optic enclosure of claim 1, wherein the set of front trunk mounting plates are mounted at the angle relative to the rear wall of the enclosure body, and the set of rear trunk mounting plates are mounted to be substantially parallel with the rear wall.

6. The fiber optic enclosure of claim 1, further comprising a splice tray configured to install in the subframe as one of the fiber optic trays, wherein the splice tray comprises a serpentine path between an entrance of the splice tray and a splice sleeve holder of the splice tray.

7. The fiber optic enclosure of claim 6, further comprising a fiber manger component comprising
a hollow cylinder configured to mount to a peg of multiple pegs formed on a base of the splice tray, and
a fiber holding tab that extends from the hollow cylinder substantially perpendicular to an axis of the hollow cylinder,
wherein the fiber manager component is rotatable about the peg.

8. The fiber optic enclosure of claim 7, wherein the fiber manager component further comprises a flyover channel formed on a top side of the hollow cylinder and configured to hold one or more fibers.

9. The fiber optic enclosure of claim 8, wherein the fiber manager component further comprises a fiber holding tab formed over the channel.

10. The fiber optic enclosure of claim 1, further comprising an interconnect tray configured to install in the subframe as one of the fiber optic trays, wherein the interconnect tray comprises an adapter mounting wall configured to removably hold fiber optic adapters.

11. The fiber optic enclosure of claim 1, further comprising a workbench configured to mount to an inside surface of a door of the enclosure, and to mount to the subframe to yield a work surface.

12. The fiber optic enclosure of claim 1, further comprising a fiber trunk entry opening on a top side of the enclosure and brushes that extend across the openings.

13. A fiber entry point enclosure, comprising:
an enclosure body;
a subframe installed on or near a bottom of the inside of the enclosure body and configured to hold fiber optic trays; and
trunk mounting plates installed above the subframe in front of a rear wall of the enclosure body and angled relative to the rear wall.

14. The fiber entry point enclosure of claim 13, wherein a trunk mounting plate of the trunk mounting plates is configured to hold multiple fiber trunks on respective trunk mounting points.

15. The fiber optic entry point enclosure of claim 14, wherein
a first trunk mounting point of the respective trunk mounting points corresponds to a first fiber optic tray of the fiber optic trays,
a second trunk mounting point of the respective trunk mounting points corresponds to a second fiber optic tray of the fiber optic trays, and
a first routing distance from the first trunk mounting point to the first fiber optic tray is substantially equal to a second routing distance from the second trunk mounting point to the second fiber optic tray.

16. The fiber entry point enclosure of claim 13, wherein
the trunk mounting plates are front trunk mounting plates, and
the fiber optic entry point enclosure further comprises rear trunk mounting plates mounted behind the front trunk mounting plates on the rear wall.

17. The fiber entry point enclosure of claim 13, further comprising a splice tray configured to install in the subframe as one of the fiber optic trays, wherein the splice tray comprises walls that form a serpentine path between an entrance of the splice tray and a splice sleeve holder of the splice tray.

18. The fiber entry point enclosure of claim 13, further comprising a workbench removably attached to a door of the enclosure body, wherein the workbench is configured to be removed from the door and mounted to the subframe to yield a work surface.

19. A system for routing optical fiber cables of fiber optic trunks to fiber optic trays, comprising:
an enclosure body that houses a subframe configured to hold fiber optic trays in a stacked arrangement, and
trunk mounting plates that are installed above the subframe such that bottom edges of the trunk mounting plate are positioned nearer to a front of the enclosure body than top edges of the trunk mounting plates.

20. The system of claim 19, wherein
a trunk mounting plate of the trunk mounting plates comprises multiple trunk mounting points comprising a pair of trunk mounting holes, and
a first routing distance from a first trunk mounting point, of the multiple trunk mounting points, to a first of the fiber optic trays corresponding to the first trunk mounting point is substantially equal to a second routing distance from a second trunk mounting point, of the multiple trunk mounting points, to a second of the fiber optic trays corresponding to the second trunk mounting point.
